(19) United States
(12) Patent Application Publication
(10) Pub. No.: US 2026/0061733 A1
(43) Pub. Date: Mar. 5, 2026

(54) NOVEL ALUMINUM-FREE HUMIDITY-REGULATING LINING PAPER FOR CIGARETTES AND PREPARATION METHOD THEREOF

(71) Applicants: CHINA NATIONAL PULP & PAPER RESEARCH INST. CO., LTD., Beijing (CN); SINOLIGHT SPECIALTY FIBER MATERIALS CO., LTD., Langfang (CN)

(72) Inventors: Xue ZHANG, Beijing (CN); Hongjie ZHANG, Beijing (CN); Leilei HOU, Beijing (CN); Yun CHENG, Beijing (CN); Quan ZHANG, Beijing (CN); Linghua CHEN, Beijing (CN); Xuemei CHEN, Beijing (CN); Chao TIAN, Beijing (CN); Chuanbo XU, Beijing (CN); Tao ZHAO, Beijing (CN)

(21) Appl. No.: 18/824,684

(22) Filed: Sep. 4, 2024

(30) Foreign Application Priority Data
Sep. 4, 2023 (CN) 202311132224.3

(51) Int. Cl. B32B 27/10; B32B 23/08; B32B 27/30

(52) U.S. Cl. CPC B32B 27/10; B32B 23/08; B32B 27/306; B32B 2250/04; B32B 2317/18; B32B 2329/04

(57) ABSTRACT

A novel aluminum-free humidity-regulating lining paper for cigarettes and a preparation method thereof are provided, where the lining paper comprises a base paper layer, a dense barrier layer, a hydrophobic functional layer, and a composite humidity-regulating layer. The dense barrier layer contains polyvinyl alcohol (PVA) and glycerol, the hydrophobic functional layer includes calcium stearate, a silane coupling agent (SCA), nanocellulose, and carboxymethyl cellulose (CMC), and the composite humidity-regulating layer comprises sodium alginate, nanoporous calcium silicate (NCS), glycerol, and hyaluronic acid. The hydrophobic functional layer, formed within a CMC matrix with nanocellulose as a physical cross-linking agent, benefits from a hydrophobic synergistic effect of calcium stearate and the SCA, providing hydrophobicity and barrier capacity without compromising the barrier properties of the PVA-based dense barrier layer under high humidity. Moreover, the lining paper achieves dynamic humidity control through the water-locking and moisturizing effect of hyaluronic acid and moisture-related properties of NCS.

### CROSS REFERENCE TO RELATED APPLICATION

This patent application claims the benefit and priority of Chinese Patent Application No. 202311132224.3, filed with the China National Intellectual Property Administration on Sep. 4, 2023, the disclosure of which is incorporated by reference herein in its entirety as part of the present application.

### TECHNICAL FIELD

The present disclosure belongs to the technical field of paper-based materials, and in particular relates to a lining paper for cigarettes with a humidity-regulating function in cigarette packaging.

### BACKGROUND

Tobacco plays an increasingly important role in the global economy. The tobacco and its products have a certain degree of hygroscopicity, and their moisture content has a certain influence on the storage, transportation, and processing of the tobacco as well as an intrinsic quality of the tobacco products. At present, the main tobacco products produced in China are cigarettes. Due to the differences in regions and seasons, the environmental humidity varies greatly from place to place, making the moisture content in cigarettes also vary to a certain extent. The moisture content in cigarettes can directly affect the smoking quality of cigarettes. An excessively high moisture content in cigarettes may cause incomplete combustion of the tobacco, resulting in the loss of cigarette aroma. At the same time, the high moisture content can also cause tobacco to mold, leading to a plummet smoking quality. On the contrary, an excessively low moisture content in cigarettes may cause the cigarette to burn too fast with an excessively high burning smoke temperature, resulting in strong, dry, spicy, and throat-irritating smoke. Therefore, appropriate moisture content plays a highly important role in the smoking quality of cigarettes.

For cigarette products, the moisture content is closely related to the moisturizing properties of cigarettes, which is affected by many factors such as tobacco characteristics, humectants, and packaging materials. In recent years, the cigarette industry has adopted smoke moisture retention or hydration to improve smoking comfort. One is to add polyol humectants to the tobacco. Although this method can maintain the moisture content of tobacco during processing and improve the processing resistance of tobacco, the polyol humectants are directly added into the tobacco and participate in combustion during smoking, causing other impurities to be introduced into the smoke, and then affecting a sensory quality of the cigarette. The other is to embed explosive beads into the filter rod through embedding plastic beads. During smoking, the explosive beads are pressed to be broken, so as to increase the humidity of smoke and improve an effect of the filter rod to intercept the aroma. However, this method greatly increases a production cost. In view of the problems existing in the above-mentioned methods of imparting moisture retention properties to cigarettes, people have begun to consider, from the perspective of cigarette packaging materials, using environmental-friendly processing technology to impart certain moisture-retention and humidity-regulating properties to the cigarette packaging materials, thereby avoiding continuous constant humidity after the cigarette box packaging is unpacked.

Lining paper for cigarettes, as a paper-based material between a cigarette pack and cigarettes, is in direct contact with the cigarettes and is an important cigarette packaging material. Generally speaking, the lining paper for cigarettes mainly plays the role of preserving aroma, blocking air and moisture, and shading light. However, traditional liner paper for cigarettes does not have a dynamic humidity control function. In recent years, some liner papers for cigarettes with different preparation processes have appeared, and some related authorized patents have also emerged, such as CN110696514B, CN114775331B, CN114086429B, CN111676729B, and CN106868933B. However, the lining papers for cigarettes involved in these preparation processes and patents either do not have the dynamic humidity control function or use metal layers such as aluminum or titanium to achieve the barrier function. The existing technology lacks environmental-friendly lining papers for cigarettes with excellent barrier properties and dynamic humidity control function. In particular, due to the large temperature and humidity differences between the north and south of China, it is necessary to give a local microenvironment in the cigarette box a certain dynamic humidity control function. This function can autonomously control the humidity of the microenvironment in the cigarette box through water lock, moisture absorption, and drainage according to humidity changes in the storage environment, so as to achieve constant-humidity preservation of the cigarettes after unpacking. This process is a key technical problem that needs to be solved in this field.

### SUMMARY

In view of the defects and shortcomings of the prior art, an objective of the present disclosure is to provide a novel aluminum-free humidity-regulating lining paper for cigarettes. On the one hand, the product uses biomass-based degradable polymers to form a dense barrier layer on the surface of a base paper layer through the desirable film-forming properties of polyvinyl alcohol (PVA). Meanwhile, the product uses a synergistic effect of calcium stearate (containing long carbon chain hydrophobic groups of stearic acid, Ca²⁺ small-molecule free ions), a silane coupling agent (hydrophobic groups, an organic-inorganic bridging agent), nanocellulose (high aspect ratio, high specific surface area, and rich active groups), and carboxymethyl cellulose (CMC) (film-forming, rich in carboxyl groups) to form a hydrophobic functional layer outside the dense barrier layer, thereby giving the lining paper excellent barrier properties and excellent molding capacity. On the other hand, natural polymers and inorganic particles are used to form a dynamic composite humidity-regulating layer by utilizing organic-inorganic physical cross-linking and water absorption-drainage-sustained release effects among sodium alginate (film-forming and water retention properties), nanoporous calcium silicate (water absorption-drainage function and sustained release properties), and hyaluronic acid (hygroscopicity, excellent water retention properties), thus giving the lining paper an outstanding dynamic humidity control function. In addition, another objective of the present disclosure is to provide a preparation method of the novel aluminum-free humidity-regulating lining paper for cigarettes.

To achieve the above objective, the present disclosure adopts the following technical solutions:

The present disclosure provides a novel aluminum-free humidity-regulating lining paper for cigarettes, including a base paper layer, a dense barrier layer, a hydrophobic functional layer, and a composite humidity-regulating layer; where the dense barrier layer and the hydrophobic functional layer are arranged on an outer surface of the base paper layer in sequence from bottom to top, while the composite humidity-regulating layer is arranged on an inner surface of the base paper layer. The dense barrier layer includes PVA and glycerol, the hydrophobic functional layer includes calcium stearate, a silane coupling agent, nanocellulose, and CMC, and the composite humidity-regulating layer includes sodium alginate, nanoporous calcium silicate, glycerol, and hyaluronic acid.

In the present disclosure, in view of the technical problems of poor barrier properties and high degree of forming of the existing aluminum-free liner paper, a double-effect barrier is creatively proposed by using the dense barrier layer and the hydrophobic functional layer. The desirable film-forming properties of PVA and a dense structure formed after film formation are utilized to effectively finish, physically cover, and fill a porous structure on the surface of the base paper layer. However, since PVA is rich in hydroxyl groups, the hydroxyl groups in PVA may combine with the hydroxyl groups of water molecules in humid air to form hydrogen bonds at high humidity, which can have a negative impact on the dense structure of the PVA coating, causing the PVA coating to gradually swell and dissolve, and greatly reducing barrier properties. Therefore, PVA coating alone cannot meet the barrier requirements under higher humidity. A layer of the hydrophobic functional layer is coated outside of the PVA-based dense barrier layer, and can effectively prevent water molecules in the air from damaging the PVA coating. The hydrophobic functional layer is composed of calcium stearate, a silane coupling agent, nanocellulose, and CMC, where a C18 hydrophobic long carbon chain in the calcium stearate and a hydrophobic long carbon chain in the silane coupling agent give the coating system a higher hydrophobic level. In addition, abundant hydroxyl groups on the nanocellulose are extremely easy to combine with carboxylic acid groups in the calcium stearate and the CMC, and the nanocellulose is easy to combine with the silane coupling agent due to high aspect ratio, high specific surface area, and nanometer size effect. In the hydrophobic functional layer, CMC forms a matrix of the hydrophobic functional layer with desirable film-forming properties; hydrophobic long carbon chains in the calcium stearate and silane coupling agent modify the coating system to be hydrophobic; Ca²⁺ ions in the nanocellulose and calcium stearate act as a physical cross-linking agent in the coating system, and the Ca²⁺ ions can be freely and flexibly dispersed in the molecular structure of CMC and nanocellulose due to its small ion volume. In summary, due to the synergistic effect of calcium stearate, silane coupling agent, nanocellulose, and CMC in terms of hydrophobicity, film-forming properties, and dispersion uniformity, the hydrophobic functional layer has desirable hydrophobicity and a certain barrier capacity.

In the present disclosure, a natural moisturizing factor, hyaluronic acid, is applied to the dynamic humidity-regulating performance of paper-based materials for the first time. Hyaluronic acid, which is rich in carboxylic acid, acetylamino, and hydroxyl groups, has a special water-retaining effect, is the best moisturizing substance discovered in nature, and can carry more than 500 times its own weight in water. The hyaluronic acid has a desirable water-locking and water-retaining effect. However, after hyaluronic acid absorbs water, it is difficult for water molecules to be removed from the molecular structure of hyaluronic acid even in a dry environment. Therefore, the organic moisturizing factor-hyaluronic acid and the inorganic particles-nanoporous calcium silicate are creatively combined to achieve the dynamic humidity control function of locking in moisture and moisturizing while draining moisture. The nanoporous calcium silicate can freely enter the long-chain multi-level structure of hyaluronic acid due to a nano-size effect. The water adsorbed in the long-chain multi-level structure of the hyaluronic acid polymer is introduced into the nano-multi-level porous structure of the nano-calcium silicate particles by the electrostatic binding effect of Si—O⁻ negative ions and H⁺ in water molecules. As a mass of introduced water increases, the existence form of water molecules in nano-calcium silicate is mainly physical adsorption. Since there is a low energy barrier of adsorption-desorption in the physical adsorption, water molecules undergo adsorption-desorption in the multi-level nanoporous structure of nano-calcium silicate due to the influence of the water vapor partial pressure in the surrounding environment, thereby being able to dynamically respond to changes in the humidity of the surrounding environment and realize a dynamic humidity control function.

Preferably, in the dense barrier layer of the novel aluminum-free humidity-regulating lining paper for cigarettes, the PVA and the glycerol are at a mass percentage ratio of (70-95) %: (5-30) %, and the dense barrier layer coating prepared by the PVA solution, the glycerol, and the water has a viscosity of 100 cp to 500 cp and a coating amount of (0.5-1) g/m².

Preferably, in the dense barrier layer of the novel aluminum-free humidity-regulating lining paper for cigarettes, the PVA in the dense barrier layer coating has a molecular weight of 120,000 to 250,000 and an alcoholysis degree of 78% to 88%.

Preferably, in the hydrophobic functional layer of the novel aluminum-free humidity-regulating lining paper for cigarettes, the hydrophobic functional layer coating has the calcium stearate with a mass fraction of 2% to 15%, the silane coupling agent with a mass fraction of 0.5% to 2%, the nanocellulose with a mass fraction of 5% to 25%, and the CMC with a mass fraction of 60% to 90%, and the hydrophobic functional layer coating has a viscosity of 200 cp to 800 cp and a coating amount of (1-3) g/m².

Preferably, in the hydrophobic functional layer of the novel aluminum-free humidity-regulating lining paper for cigarettes, the calcium stearate is the commercially available calcium stearate emulsion, the silane coupling agent is one selected from the group consisting of KH550, KH560, KH580, A-151, and A-171, the nanocellulose has a diameter of 10 nm to 100 nm and a length of 1 μm to 30 μm, and the CMC has a molecular weight of 150,000 to 300,000 in the hydrophobic functional layer coating.

Preferably, in the composite humidity-regulating layer of the novel aluminum-free humidity-regulating lining paper for cigarettes, the composite humidity-regulating layer coating includes the following raw materials in percentage by mass: 50% to 80% of the sodium alginate, 10% to 30% of the nanoporous calcium silicate, 5% to 20% of the glycerol, and 0.5% to 2% of the hyaluronic acid, and the composite humidity-regulating layer coating has a viscosity of 300 cp to 900 cp and a coating amount of (2-5) g/m².

Preferably, in the composite humidity-regulating layer of the novel aluminum-free humidity-regulating lining paper for cigarettes, the sodium alginate has a molecular weight dispersion index (Mw/Mn) of 1.9 to 2.3 and a mannuronic acid/guluronic acid (M/G) monosaccharide ratio of 0.5 to 1, the nanoporous calcium silicate has a particle size of 5 nm to 100 nm, and the hyaluronic acid has a molecular weight of 500,000 to 3,000,000.

The present disclosure further provides a preparation method of the novel aluminum-free humidity-regulating lining paper for cigarettes, including the following steps:
S1, preparation of a dense barrier layer coating: preparing a PVA solution of a certain mass concentration, mixing the PVA solution and the glycerol at a mass percentage ratio of (70-95) %: (5-30) %, and adding water to adjust a viscosity of the dense barrier layer coating to 100 cp to 500 cp for later use;
S2, preparation of a hydrophobic functional layer coating: preparing a CMC aqueous solution of a certain mass concentration, selecting a commercially available calcium stearate emulsion and a commercially available nanocellulose hydrogel, and preparing the hydrophobic functional layer coating according to the calcium stearate with a mass fraction of 2% to 15%, the silane coupling agent with a mass fraction of 0.5% to 2%, the nanocellulose with a mass fraction of 5% to 25%, and the CMC with a mass fraction of 60% to 90%, and adding water to adjust a viscosity of the hydrophobic functional layer coating to 200 cp to 800 cp for later use;
S3, preparation of a composite humidity-regulating layer coating: preparing a sodium alginate aqueous solution of a certain mass concentration, mixing with a certain amount of the hyaluronic acid, adding the nanoporous calcium silicate and the glycerol in sequence, preparing the composite humidity-regulating layer coating according to the sodium alginate with a mass fraction of 50% to 80%, the nanoporous calcium silicate with a mass fraction of 10% to 30%, the glycerol with a mass fraction of 5% to 20%, and the hyaluronic acid with a mass fraction of 0.5% to 2%, and adding water to adjust a viscosity of the composite humidity-regulating layer coating to 300 cp to 900 cp for later use;
S4, coating the dense barrier layer coating on one side of the base paper layer by any coating process selected from the group consisting of scraper blade coating, curtain coating, and scraper bar coating, and conducting non-contact hot air drying at 80° C. to 120° C. for 5 min to 20 min to obtain a coated paper with the dense barrier layer on the one side;
S5, coating the hydrophobic functional layer coating on the one side with the dense barrier layer of the coated paper by the any coating process selected from the group consisting of the scraper blade coating, the curtain coating, and the scraper bar coating, and conducting non-contact hot air drying at 100° C. to 120° C. for 5 min to 20 min to obtain a coated paper with the dense barrier layer and the hydrophobic functional layer coated in sequence on the one side; and
S6, coating the composite humidity-regulating layer on an uncoated side of the coated paper with the dense barrier layer and the hydrophobic functional layer in sequence by the any coating process selected from the group consisting of the scraper blade coating, the curtain coating, and the scraper bar coating (where if the dense barrier layer and the hydrophobic functional layer are coated on the outer surface of the base paper layer, the composite humidity-regulating layer is coated on the inner surface of the base paper layer), and conducting non-contact hot air drying at 100° C. to 120° C. for 10 min to 30 min to obtain the novel aluminum-free humidity-regulating lining paper for cigarettes.

In the novel aluminum-free humidity-regulating lining paper for cigarettes and the preparation method thereof provided by the present disclosure, a dense barrier layer with high ductility is first formed on a surface of the base paper layer for cigarettes by the desirable film-forming and barrier properties of PVA and the plasticizing properties of glycerol. In order to solve the problem of reduced barrier properties of PVA coating under high humidity, by utilizing a hydrophobic synergistic effect of hydrophobic substances—the calcium stearate and the silane coupling agent, a hydrophobic functional layer with hydrophobicity and certain barrier capacity is formed in a CMC matrix with the help of nanocellulose as a physical cross-linking agent. Under the action of the double-layer functional coating layer of the dense barrier layer and the hydrophobic functional layer, the aluminum-free liner paper for cigarettes is endowed with excellent barrier properties (low air permeability and low water vapor transmission rate) under high humidity. In addition, in view of the technical problems and practical needs of dynamic humidity control of cigarette liner paper, a dynamic response to changes in environmental humidity is achieved by a desirable water-locking and moisturizing effect of a natural moisturizing factor—the hyaluronic acid as well as moisture absorption, drainage, and sustained-release effects of the nanoporous calcium carbonate. At the same time, the Ca²⁺ ions in nanoporous calcium silicate can promote the cross-linking of sodium alginate to form a complex gel structure, thereby forming a stable three-dimensional network structure through extension and dehydration in the aqueous phase, which is beneficial to the structural uniformity and stability of the sodium alginate-based composite humidity-regulating layer. Since the selected biomass polymer material has high ductility, the prepared coating exhibits a lower degree of molding and can well meet the subsequent processing requirements of aluminum-free liner paper for cigarettes. Therefore, the novel aluminum-free humidity-regulating lining paper for cigarettes has obvious beneficial effects: desirable softness, dense surface structure, and low degree of molding, thereby overcoming the defects of the existing aluminum-free lining paper for cigarettes in the above aspects. Secondly, the novel aluminum-free humidity-regulating lining paper for cigarettes achieves a dynamic response to the humidity change of the local microenvironment by absorbing water to retain moisture and draining water to release moisture, thereby controlling the humidity changes of the local microenvironment within an acceptable range. Finally, the novel aluminum-free humidity-regulating lining paper for cigarettes has an environmental-friendly production process, and the raw materials used are biodegradable materials.

### BRIEF DESCRIPTION OF THE DRAWINGS

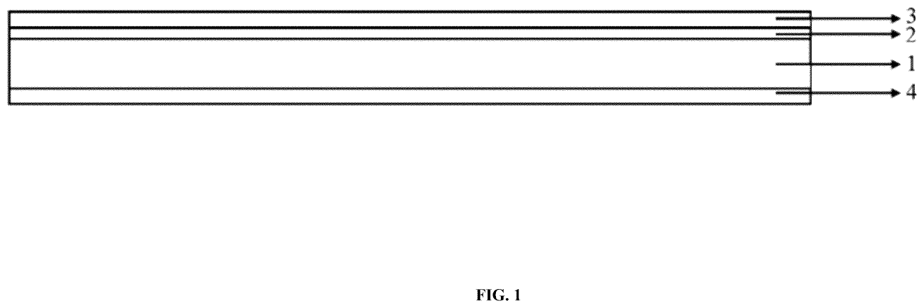

FIG. 1 shows a schematic structural diagram of the novel aluminum-free humidity-regulating lining paper for cigarettes in the present disclosure; where
reference numerals are: 1—base paper layer, 2—dense barrier layer, 3—hydrophobic functional layer, 4—composite humidity-regulating layer; and
the hydrophobic functional layer includes calcium stearate, a silane coupling agent, nanocellulose, and CMC, and the composite humidity-regulating layer includes sodium alginate, nanoporous calcium silicate, glycerol, and hyaluronic acid.

### DETAILED DESCRIPTION OF THE EMBODIMENTS

In order to make the objectives, technical solutions, and beneficial effects of the present disclosure more clear, preferred examples of the present disclosure will be described in detail below in conjunction with the accompanying drawings to facilitate understanding by technical personnel.

As shown in FIG. 1, the novel aluminum-free humidity-regulating lining paper for cigarettes includes a base paper layer 1, where an upper surface of the base paper layer is provided with a dense barrier layer 2 and a hydrophobic functional layer 3 from inside to outside, and a lower surface of the base paper layer is provided with a composite humidity-regulating layer 4.

Specifically, the base paper layer 1 can be a commercially available lining base paper for cigarettes. The dense barrier layer 2 includes PVA and glycerol, the hydrophobic functional layer 3 includes calcium stearate, a silane coupling agent, nanocellulose, and CMC, and the composite humidity-regulating layer 4 includes sodium alginate, nanoporous calcium silicate, glycerol, and hyaluronic acid.

Preferably, in the dense barrier layer 2 of the novel aluminum-free humidity-regulating lining paper for cigarettes, the PVA and the glycerol are at a mass percentage ratio of (70-95) %: (5-30) %, and the dense barrier layer coating prepared by the PVA solution, the glycerol, and the water has a viscosity of 100 cp to 500 cp and a coating amount of (0.5-1) g/m².

Preferably, in the dense barrier layer 2 of the novel aluminum-free humidity-regulating lining paper for cigarettes, the PVA in the dense barrier layer coating has a molecular weight of 120,000 to 250,000 and an alcoholysis degree of 78% to 88%.

Preferably, in the hydrophobic functional layer 3 of the novel aluminum-free humidity-regulating lining paper for cigarettes, the hydrophobic functional layer coating has the calcium stearate with a mass fraction of 2% to 15%, the silane coupling agent with a mass fraction of 0.5% to 2%, the nanocellulose with a mass fraction of 5% to 25%, and the CMC with a mass fraction of 60% to 90%, and the hydrophobic functional layer coating has a viscosity of 200 cp to 800 cp and a coating amount of (1-3) g/m².

Preferably, in the hydrophobic functional layer 3 of the novel aluminum-free humidity-regulating lining paper for cigarettes, the calcium stearate is the commercially available calcium stearate emulsion, the silane coupling agent is any one selected from the group consisting of KH550, KH560, KH580, A-151, and A-171, the nanocellulose has a diameter of 10 nm to 100 nm and a length of 1 μm to 30 μm, and the CMC has a molecular weight of 150,000 to 300,000 in the hydrophobic functional layer coating.

Preferably, in the composite humidity-regulating layer 4 of the novel aluminum-free humidity-regulating lining paper for cigarettes, the composite humidity-regulating layer coating includes the following raw materials in percentage by mass: 50% to 80% of the sodium alginate, 10% to 30% of the nanoporous calcium silicate, 5% to 20% of the glycerol, and 0.5% to 2% of the hyaluronic acid, and the composite humidity-regulating layer coating has a viscosity of 300 cp to 900 cp and a coating amount of (2-5) g/m².

Preferably, in the composite humidity-regulating layer 4 of the novel aluminum-free humidity-regulating lining paper for cigarettes, the sodium alginate has a molecular weight dispersion index (Mw/Mn) of 1.9 to 2.3 and a mannuronic acid/guluronic acid (M/G) monosaccharide ratio of 0.5 to 1, the nanoporous calcium silicate has a particle size of 5 nm to 100 nm, and the hyaluronic acid has a molecular weight of 500,000 to 3,000,000.

A preparation method of the novel aluminum-free humidity-regulating lining paper for cigarettes includes the following steps:

### Example 1

S1, preparation of a dense barrier layer coating: commercially available PVA with a molecular weight of 120,000 and an alcoholysis degree of 78% were selected to prepare a PVA aqueous solution with a mass concentration of 2%, and a PVA/glycerol/water mixed coating with a viscosity of 100 cp was prepared according to a mass percentage ratio of PVA to glycerol of 70%: 30% for later use.
S2, preparation of a hydrophobic functional layer coating: a CMC aqueous solution with a mass concentration of 1% was prepared by CMC with a molecular weight of 200,000, a commercially available calcium stearate emulsion and a commercially available nanocellulose hydrogel (diameter 20 nm, length 4 μm) and a silane coupling agent KH550 were selected, and the hydrophobic functional layer coating was prepared according to the calcium stearate with a mass fraction of 2%, the silane coupling agent with a mass fraction of 1.5%, the nanocellulose with a mass fraction of 10%, and the CMC with a mass fraction of 86.5%, and water was added to adjust a viscosity of the hydrophobic functional layer coating to 300 cp for later use.
S3, preparation of a composite humidity-regulating layer coating: a sodium alginate aqueous solution with a mass concentration of 2% was prepared by using commercially available sodium alginate with a molecular weight dispersion index (Mw/Mn) of 1.9 and a M/G monosaccharide ratio of 0.5, mixed with commercially available hyaluronic acid with a molecular weight of 1,000,000, the nanoporous calcium silicate and the glycerol with a particle size of 5 nm were added in sequence, the composite humidity-regulating layer coating was prepared according to the sodium alginate with a mass fraction of 69.5%, the nanoporous calcium silicate with a mass fraction of 20%, the glycerol with a mass fraction of 10%, and the hyaluronic acid with a mass fraction of 0.5%, and water was added to adjust a viscosity of the composite humidity-regulating layer coating to 300 cp for later use.
S4, the dense barrier layer coating was coated on one side of the base paper layer by scraper bar coating at a coating amount of 0.5 g/m², and non-contact hot air drying was conducted at 80° C. for 20 min to obtain a coated paper with the dense barrier layer on the one side.
S5, the hydrophobic functional layer coating was coated on the one side with the dense barrier layer of the coated paper by the scraper bar coating at a coating amount of 1 g/m², and non-contact hot air drying was conducted at 100° C. for 20 min to obtain a coated paper with the dense barrier layer and the hydrophobic functional layer coated in sequence on the one side.
S6, the composite humidity-regulating layer on an uncoated side of the coated paper with the dense barrier layer and the hydrophobic functional layer in sequence by the scraper bar coating at a coating amount of 2 g/m², and non-contact hot air drying was conducted at 120° C. for 10 min to obtain the novel aluminum-free humidity-regulating lining paper for cigarettes.

### Example 2

This example was the same as Example 1, except that: in step S2, the silane coupling agent was A-151, and the hydrophobic functional layer coating was prepared according to the calcium stearate with a mass fraction of 15%, the silane coupling agent with a mass fraction of 0.5%, the nanocellulose with a mass fraction of 5%, and the CMC with a mass fraction of 79.5%, and then a proper amount of water was added to adjust a viscosity of the hydrophobic functional layer coating to 200 cp for later use; in step S4, scraper blade coating was selected; in step S5, the coating amount was 1.5 g/m² and the drying was conducted at 110° C.; in step S6, the coating amount was 3 g/m² and the drying was conducted for 15 min.

### Example 3

This example was the same as Example 1, except that: in step S1, a PVA/glycerol/water mixed coating with a viscosity of 500 cp was prepared according to the mass percentage of PVA to glycerol of 95%: 5% for later use; in step S2, the silane coupling agent was KH560, and the hydrophobic functional layer coating was prepared according to the calcium stearate with a mass fraction of 5%, the silane coupling agent with a mass fraction of 2%, the nanocellulose with a mass fraction of 10%, and the CMC with a mass fraction of 83%; in step S3, commercially available sodium alginate with a molecular weight dispersion index (Mw/Mn) of 2.3 and an M/G monosaccharide ratio of 1 was selected, and the composite humidity-regulating layer coating was prepared according to 53% sodium alginate, 30% nanoporous calcium silicate, 15% glycerol, and 2% hyaluronic acid, and finally water was added to adjust a viscosity of the composite humidity-regulating layer coating to 500 cp for later use; in step S4, the coating amount was 1 g/m²; in step S6, the coating amount was 3.5 g/m², and the drying was conducted for 15 min.

### Example 4

This example was the same as Example 1, except that: in step S2, the hydrophobic functional layer coating was prepared according to the calcium stearate with a mass fraction of 3%, the silane coupling agent with a mass fraction of 1%, the nanocellulose with a mass fraction of 15%, and the CMC with a mass fraction of 81%.

### Example 5

This example was the same as Example 1, except that: in step S3, the composite humidity-regulating layer coating was prepared according to 63.5% sodium alginate, 15% nanoporous calcium silicate, 20% glycerol, and 1.5% hyaluronic acid, and finally water was added to adjust a viscosity of the composite humidity-regulating layer coating to 900 cp for later use; in step S6, scraper blade coating was used, the coating amount was 5 g/m², and the drying was conducted for 30 min.

### Example 6

This example was the same as Example 1, except that: in step S1, a PVA/glycerol/water mixed coating with a viscosity of 300 cp was prepared according to the mass percentage of PVA to glycerol of 80%: 20% for later use; in step S2, the silane coupling agent was A-171, and the hydrophobic functional layer coating was prepared according to the calcium stearate with a mass fraction of 10%, the silane coupling agent with a mass fraction of 1.8%, the nanocellulose with a mass fraction of 15%, and the CMC with a mass fraction of 86.7%; in step S3, commercially available sodium alginate with a molecular weight dispersion index (Mw/Mn) of 2.2 and an M/G monosaccharide ratio of 0.8 was selected, and the composite humidity-regulating layer coating was prepared according to 70.3% sodium alginate, 19% nanoporous calcium silicate, 10% glycerol, and 0.7% hyaluronic acid, and finally water was added to adjust a viscosity of the composite humidity-regulating layer coating to 700 cp for later use; in step S4, the coating amount was 1.5 g/m².

### Example 7

This example was the same as Example 1, except that: in step S2, the hydrophobic functional layer coating was prepared according to the calcium stearate with a mass fraction of 12%, the silane coupling agent with a mass fraction of 0.6%, the nanocellulose with a mass fraction of 19%, and the CMC with a mass fraction of 68.4%.

### Example 8

This example was the same as Example 1, except that: in step S2, the silane coupling agent was KH580; in step S4, curtain coating was used, and the coating amount was 0.8 g/m²; in step S5, curtain coating was used, the coating amount was 2.5 g/m², and the drying was conducted at 120° C.; in step S6, the coating amount was 4 g/m², and the drying was conducted for 22 min.

Table 1 showed a comparison of the barrier properties of the novel aluminum-free humidity-regulating lining paper for cigarettes prepared in Examples 1 to 8 and the commercially available composite aluminum foil lining paper samples in terms of air permeability, water vapor transmission rate and the like. In addition, it was verified that the novel aluminum-free humidity-regulating lining paper for cigarettes, when used for cigarette packaging, could dynamically regulate the humidity of the open environment in which the cigarette tobacco was located, thereby maintaining the moisture content of the cigarettes within a relatively small range. 8 samples of novel aluminum-free humidity-regulating lining paper for cigarettes and samples of composite aluminum foil lining paper were placed in a small cigarette box (containing 20 cigarettes) according to the cigarette production model, and then placed in a constant-temperature and constant-humidity chamber to test the humidity controlling performance of the novel aluminum-free humidity-control lining paper for cigarettes. The characterization was conducted by comparing the moisture content (%) of cigarettes unpacked 48 h after being placed in a high-temperature and high-humidity environment (38° C., 80% RH), a dry environment (38° C., 30% RH), and a normal-humidity environment (38° C., 50% RH).

TABLE 1
Barrier performance indicators of novel aluminum-free humidity-regulating lining paper for cigarettes

| | | | | Moisture | | |
|---|---|---|---|---|---|---|
| | | | | content of | Moisture | Moisture |
| | | | | cigarette (%, | content of | content of |
| | | | Water vapor | 48 h after | cigarette (%, | cigarette (%, |
| | | | transmittance | unpacking in high- | 48 h after | 48 h after |
| | | Air | (g/m² · d, | temperature and | unpacking in | unpacking in |
| | Quantification | permeability | 38° C., 92% | high-humidity | dry | normal |
| Sample | (g/m²) | (min/10 mL) | RH) | environment) | environment) | environment) |
| Example 1 | 75.5 | 29 | 17.1 | 11.41 | 11.07 | 11.15 |
| Example 2 | 77 | 22 | 16.9 | 11.45 | 11.14 | 11.15 |
| Example 3 | 77 | 23 | 16.1 | 11.34 | 11.13 | 11.10 |
| Example 4 | 75.5 | 26 | 20.1 | 11.35 | 11.06 | 11.12 |
| Example 5 | 77.5 | 21 | 15.4 | 11.19 | 11.12 | 11.14 |
| Example 6 | 76 | 25 | 16.7 | 11.24 | 11.09 | 11.15 |
| Example 7 | 75.5 | 30 | 17.9 | 11.39 | 11.08 | 11.16 |
| Example 8 | 79.3 | 27 | 14.9 | 11.21 | 11.14 | 11.17 |
| Control | 81 | 32 | 16.7 | 14.01 | 8.91 | 11.14 |

As shown in Table 1, in terms of barrier properties, the test data of air permeability and water vapor transmittance of Examples 1 to 8 were similar to those of the control sample (commercially available composite aluminum foil lining paper). Examples 2, 3, 5, and 8 exhibited relatively desirable barrier properties due to the large coating amounts of the hydrophobic functional layer and the composite humidity-regulating layer. The test data of air permeability and water vapor transmittance showed that the barrier properties of the novel aluminum-free humidity-regulating lining paper for cigarettes prepared in Examples 1 to 8 were comparable to those of the commercially available composite aluminum foil lining paper. This indicated that the novel aluminum-free humidity-regulating lining paper for cigarettes could meet the requirements of cigarette packaging for the barrier properties of lining paper for cigarettes in practical applications.

In addition, the changes in moisture content of cigarettes under different temperature and humidity conditions in Table 1 showed that although the composite aluminum foil lining paper had desirable barrier properties, it did not have dynamic humidity control properties. As a result, the moisture content of the wrapped cigarettes fluctuated greatly after unpacking under different temperature and humidity conditions (the moisture content of cigarettes increased by 25.8% under high temperature and high humidity conditions; while the moisture content of cigarettes decreased by 20.0% under dry conditions). By comparison, it was found that after the novel aluminum-free humidity-regulating lining paper for cigarettes in Examples 1 to 8 was placed in cigarette packaging according to the cigarette production mode, there was an extremely small fluctuation range of the moisture content of the cigarettes after unpacking under different temperature and humidity conditions. This showed that the novel aluminum-free humidity-regulating lining paper for cigarettes prepared in Examples 1 to 8 had desirable dynamic humidity-regulating performance. In a high-temperature and high-humidity environment, the lining paper could reduce the humidity of the local microenvironment where the cigarette was located through water absorption, thereby maintaining the moisture content of the cigarette at a normal level. In a dry environment, the lining paper could increase the humidity of the local microenvironment where the cigarette was located through drainage, thereby maintaining the moisture content of the cigarette at a normal level. In summary, the storage environment had little influence on the moisture content of cigarettes wrapped with the novel aluminum-free humidity-regulating lining paper for cigarettes, indicating that the novel aluminum-free humidity-regulating lining paper for cigarettes showed desirable environmental humidity response capability and sensitive dynamic humidity control performance.

Finally, it should be noted that the above preferred examples are only intended to illustrate the technical solutions of the present disclosure and not to limit them. Although the present disclosure has been described in detail through the above preferred examples, those skilled in the art should appreciate that various changes may be made to the present disclosure in form and detail without departing from the scope of the present disclosure as defined by the claims.

What is claimed is:

1. A preparation method of a novel aluminum-free humidity-regulating lining paper for cigarettes, wherein the novel aluminum-free humidity-regulating lining paper for cigarettes comprises a base paper layer, a dense barrier layer, a hydrophobic functional layer, and a composite humidity-regulating layer; the dense barrier layer and the hydrophobic functional layer are arranged in sequence on an outer surface of the base paper layer from bottom to top, and the composite humidity-regulating layer is arranged on an inner surface of the base paper layer; the dense barrier layer comprises polyvinyl alcohol (PVA) and glycerol, the hydrophobic functional layer comprises calcium stearate, a silane coupling agent, nanocellulose, and carboxymethyl cellulose (CMC), and the composite humidity-regulating layer comprises sodium alginate, nanoporous calcium silicate, glycerol, and hyaluronic acid; and
the preparation method of the novel aluminum-free humidity-regulating lining paper for cigarettes comprises the following steps:
S1, preparation of a dense barrier layer coating: preparing a PVA solution of a certain mass concentration, mixing the PVA solution and the glycerol at a mass percentage ratio of (70-95) %: (5-30) %, and adding water to adjust a viscosity of the dense barrier layer coating to 100 cp to 500 cp for later use;
S2, preparation of a hydrophobic functional layer coating: preparing a CMC aqueous solution of a certain mass concentration, selecting a commercially available calcium stearate emulsion and a commercially available nanocellulose hydrogel, and preparing the hydrophobic functional layer coating according to the calcium stearate with a mass fraction of 2% to 15%, the silane coupling agent with a mass fraction of 0.5% to 2%, the nanocellulose with a mass fraction of 5% to 25%, and the CMC with a mass fraction of 60% to 90%, and adding water to adjust a viscosity of the hydrophobic functional layer coating to 200 cp to 800 cp for later use;
S3, preparation of a composite humidity-regulating layer coating: preparing a sodium alginate aqueous solution of a certain mass concentration, mixing with a certain amount of the hyaluronic acid, adding the nanoporous calcium silicate and the glycerol in sequence, preparing the composite humidity-regulating layer coating according to the sodium alginate with a mass fraction of 50% to 80%, the nanoporous calcium silicate with a mass fraction of 10% to 30%, the glycerol with a mass fraction of 5% to 20%, and the hyaluronic acid with a mass fraction of 0.5% to 2%, and adding water to adjust a viscosity of the composite humidity-regulating layer coating to 300 cp to 900 cp for later use;
S4, coating the dense barrier layer coating on one side of the base paper layer by any coating process selected from the group consisting of scraper blade coating, curtain coating, and scraper bar coating, and conducting non-contact hot air drying at 80° C. to 120° C. for 5 min to 20 min to obtain a coated paper with the dense barrier layer on the one side;
S5, coating the hydrophobic functional layer coating on the one side with the dense barrier layer of the coated paper by the any coating process selected from the group consisting of the scraper blade coating, the curtain coating, and the scraper bar coating, and conducting non-contact hot air drying at 100° C. to 120° C. for 5 min to 20 min to obtain a coated paper with the dense barrier layer and the hydrophobic functional layer coated in sequence on the one side; and
S6, coating the composite humidity-regulating layer on an uncoated side of the coated paper with the dense barrier layer and the hydrophobic functional layer in sequence by the any coating process selected from the group consisting of the scraper blade coating, the curtain coating, and the scraper bar coating, wherein if the dense barrier layer and the hydrophobic functional layer are coated on the outer surface of the base paper layer, the composite humidity-regulating layer is coated on the inner surface of the base paper layer, and conducting non-contact hot air drying at 100° C. to 120° C. for 10 min to 30 min to obtain the novel aluminum-free humidity-regulating lining paper for cigarettes.

2. The preparation method according to claim 1, wherein in the dense barrier layer of the novel aluminum-free humidity-regulating lining paper for cigarettes, the PVA and the glycerol are at a mass percentage ratio of (70-95) %: (5-30) %, and the dense barrier layer coating prepared by the PVA solution, the glycerol, and the water has a viscosity of 100 cp to 500 cp and a coating amount of (0.5-1) g/m².

3. The preparation method according to claim 1, wherein in the dense barrier layer of the novel aluminum-free humidity-regulating lining paper for cigarettes, the PVA in the dense barrier layer coating has a molecular weight of 120,000 to 250,000 and an alcoholysis degree of 78% to 88%.

4. The preparation method according to claim 1, wherein in the hydrophobic functional layer of the novel aluminum-free humidity-regulating lining paper for cigarettes, the hydrophobic functional layer coating comprises the calcium stearate with a mass fraction of 2% to 15%, the silane coupling agent with a mass fraction of 0.5% to 2%, the nanocellulose with a mass fraction of 5% to 25%, and the CMC with a mass fraction of 60% to 90%, and the hydrophobic functional layer coating has a viscosity of 200 cp to 800 cp and a coating amount of (1-3) g/m².

5. The preparation method according to claim 1, wherein in the hydrophobic functional layer of the novel aluminum-free humidity-regulating lining paper for cigarettes, the calcium stearate is the commercially available calcium stearate emulsion, the silane coupling agent is one selected from the group consisting of KH550, KH560, KH580, A-151, and A-171, the nanocellulose has a diameter of 10 nm to 100 nm and a length of 1 μm to 30 μm, and the CMC has a molecular weight of 150,000 to 300,000 in the hydrophobic functional layer coating.

6. The preparation method according to claim 1, wherein in the composite humidity-regulating layer of the novel aluminum-free humidity-regulating lining paper for cigarettes, the composite humidity-regulating layer coating comprises the following raw materials in percentage by mass: 50% to 80% of the sodium alginate, 10% to 30% of the nanoporous calcium silicate, 5% to 20% of the glycerol, and 0.5% to 2% of the hyaluronic acid, and the composite humidity-regulating layer coating has a viscosity of 300 cp to 900 cp and a coating amount of (2-5) g/m².

7. The preparation method according to claim 1, wherein in the composite humidity-regulating layer of the novel aluminum-free humidity-regulating lining paper for cigarettes, the sodium alginate has a molecular weight dispersion index (Mw/Mn) of 1.9 to 2.3 and a mannuronic acid/guluronic acid (M/G) monosaccharide ratio of 0.5 to 1, the nanoporous calcium silicate has a particle size of 5 nm to 100 nm, and the hyaluronic acid has a molecular weight of 500,000 to 3,000,000.

8. A novel aluminum-free humidity-regulating lining paper for cigarettes prepared by the preparation method according to claim 1.

9. The novel aluminum-free humidity-regulating lining paper for cigarettes according to claim 8, wherein in the dense barrier layer of the novel aluminum-free humidity-regulating lining paper for cigarettes, the PVA and the glycerol are at a mass percentage ratio of (70-95) %: (5-30) %, and the dense barrier layer coating prepared by the PVA solution, the glycerol, and the water has a viscosity of 100 cp to 500 cp and a coating amount of (0.5-1) g/m².

10. The novel aluminum-free humidity-regulating lining paper for cigarettes according to claim 8, wherein in the dense barrier layer of the novel aluminum-free humidity-regulating lining paper for cigarettes, the PVA in the dense barrier layer coating has a molecular weight of 120,000 to 250,000 and an alcoholysis degree of 78% to 88%.

11. The novel aluminum-free humidity-regulating lining paper for cigarettes according to claim 8, wherein in the hydrophobic functional layer of the novel aluminum-free humidity-regulating lining paper for cigarettes, the hydrophobic functional layer coating comprises the calcium stearate with a mass fraction of 2% to 15%, the silane coupling agent with a mass fraction of 0.5% to 2%, the nanocellulose with a mass fraction of 5% to 25%, and the CMC with a mass fraction of 60% to 90%, and the hydrophobic functional layer coating has a viscosity of 200 cp to 800 cp and a coating amount of (1-3) g/m².

12. The novel aluminum-free humidity-regulating lining paper for cigarettes according to claim 8, wherein in the hydrophobic functional layer of the novel aluminum-free humidity-regulating lining paper for cigarettes, the calcium stearate is the commercially available calcium stearate emulsion, the silane coupling agent is one selected from the group consisting of KH550, KH560, KH580, A-151, and A-171, the nanocellulose has a diameter of 10 nm to 100 nm and a length of 1 μm to 30 μm, and the CMC has a molecular weight of 150,000 to 300,000 in the hydrophobic functional layer coating.

13. The novel aluminum-free humidity-regulating lining paper for cigarettes according to claim 8, wherein in the composite humidity-regulating layer of the novel aluminum-free humidity-regulating lining paper for cigarettes, the composite humidity-regulating layer coating comprises the following raw materials in percentage by mass: 50% to 80% of the sodium alginate, 10% to 30% of the nanoporous calcium silicate, 5% to 20% of the glycerol, and 0.5% to 2% of the hyaluronic acid, and the composite humidity-regulating layer coating has a viscosity of 300 cp to 900 cp and a coating amount of (2-5) g/m².

14. The novel aluminum-free humidity-regulating lining paper for cigarettes according to claim 8, wherein in the composite humidity-regulating layer of the novel aluminum-free humidity-regulating lining paper for cigarettes, the sodium alginate has a molecular weight dispersion index (Mw/Mn) of 1.9 to 2.3 and a mannuronic acid/guluronic acid (M/G) monosaccharide ratio of 0.5 to 1, the nanoporous calcium silicate has a particle size of 5 nm to 100 nm, and the hyaluronic acid has a molecular weight of 500,000 to 3,000,000.
